(19) United States
(12) Patent Application Publication
(10) Pub. No.: US 2011/0024060 A1
(43) Pub. Date: Feb. 3, 2011

(54) PANEL

(75) Inventor: Alan Brownbill, Kingscliff (AU)

Correspondence Address: CANTOR COLBURN LLP, 20 Church Street, 22nd Floor, Hartford, CT, 06103, US

(73) Assignees: Danielle Tiffany BROWNBILL, KINGSCLIFF (AU); Alan BROWNBILL, KINGSCLIFF (AU)

(21) Appl. No.: 12/446,350

(22) PCT Filed: Oct. 18, 2007
(86) PCT No.: PCT/AU07/01590

§ 371 Date: Oct. 25, 2010

(30) Foreign Application Priority Data
Oct. 18, 2006 (AU) 2006230672

(51) Int. Cl. E06B 9/00

(52) U.S. Cl. 160/188

(57) ABSTRACT

A panel including a plurality of first members disposed in a first direction, at least one second member disposed in a second direction provided with a longitudinal opening extending at least partially through the at least one second member; a plurality of lateral openings intersecting the longitudinal opening to receive at least a portion of respective first members, and at least one locking member provided adjacent each lateral opening to abut a first member forced into the lateral opening, to lock the first member relative to the second member.

### FIELD OF THE INVENTION

The present invention relates to panels and attachment means for attaching one member to another and in particular to an improved style of construction for panels including lattice, screens, fencing, roofing, awnings and the like.

### BACKGROUND ART

Panel structures are very popular and are used for many purposes. They are generally required to combine desirable characteristics of strength, light weight, and low cost. A typical fence structure for example, is formed from straight elements such as paling elements arranged in a generally vertical direction with one or more generally horizontal rail elements in a crossing pattern and fastened together, forming openings between the palings, but preventing entry or exit of anything larger than the opening dimension. A screening fence panel is typically formed from a pair at least of vertical members and a number of horizontally oriented slat members.

By varying structural dimensions and relationships in the assembly of a conventional panel structure, the functionality, style and security provided by the panel may be varied.

In construction of conventional panels, the members must be attached to one another in some manner. These are generally fixed to one another using a fastener of some kind, usually nails, screws or staples which extend through both members. For metal panels, welding or a similar process may be used.

The areas where the panel members overlap are also sometimes provided with a rebated portion allowing the members to fit together forming a structure having a single slat thickness. Rebating however generally only works well with wooden constructions, metal being difficult to apply a rebate to.

Both the method of using fasteners and the provision of rebates weaken the panel structure. They provide points of weakness about which the panel members in particular may splinter.

Panels formed in the usual ways also tend to sag when not supported or when the panel is larger. The weight of the members and the entire panel bears on the fasteners and the rebates and may affect the strength or integrity of the panel.

Panels may also be manufactured using a preformed panel often made using a plastic sheet with the pattern of rails and palings stamped out of the sheet. Panels formed in this manner are quite thin, as it must be pressed out by a machine while the plastic is still cooling after the sheet is extruded. This type of plastic panel is usually weaker and may be used for ornamental applications. It is generally unsuitable for security situations and also tends to sag.

The most common materials used in the construction of panels are wood, plastic and light metals such as aluminium. Wood has many disadvantages, such as being relatively heavy for a given strength, as well as splitting and breaking under impact. Furthermore, wood will tend to rot and decay under most conditions and must be protected either by a preservative finish using an expensive chemical treatment or else painted with appropriate decorative finishes which must be reapplied periodically. Thus the complete cost of a wooden panel is not only the original cost of erecting it, but also the continuing cost of maintenance and repair.

In order to overcome the problems with wood as a panel material, particularly for external applications, a number of substitutes have been proposed, particularly plastics, and of these polyvinyl chloride or PVC has been one of the most popular. PVC has the advantages of easy fabrication by extrusion, molding and other processes, as well as reasonable cost and durability, since it can easily be coated with the necessary protective and finishing materials. PVC is however generally weaker than metals.

Aluminium is also used in construction of panels and is used particularly in security paneling. These constructions are often riveted together and the rivets therefore offer points of weakness about which the panel may bend or be deformed.

It has also been found that panels manufactured of metal are particularly prone to rattling and creating a noise disturbance if a force is applied, for example on a windy day. It would be advantageous to form a panel that was assembled to provide a strong panel and also one that possessed anti-rattle features.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a panel, which may at least partially overcome the abovementioned disadvantages or provide the consumer with a useful or commercial choice.

In a first form, the invention resides in a panel including

a. a plurality of first members disposed in a first direction,

b. at least one second member disposed in a second direction provided with
i. a longitudinal opening extending at least partially through the at least one second member;
ii. a plurality of lateral openings intersecting the longitudinal opening to receive at least a portion of respective first members, and
iii. at least one locking member provided adjacent each lateral opening to abut a first member forced into the lateral opening, to lock the first member relative to the second member.

The locking members are suitably located inside the second member and therefore, are hidden from sight. Panels may be formed in this manner without rivets or other fasteners. The panel is also less likely to sag under its own weight. The removal of the overlapping slats results in a slimmer panel which may be used in security situations as doors or window panels or in a larger form as a screen or wall divider panel. Depending upon the shape of the first and second members, the panel may also be used a roof, balustrade or awning. The panel may also be easily assembled by unskilled workers without the use of any specialized or heavy equipment.

Each first member may preferably be an elongate member. The members may of course be of any cross-section required by a user or manufacturer of the panels. For example, a round member may be preferred by a consumer for aesthetic reasons or to reduce the appearance of sharp angles in the panel. The members may preferably not be rectangular or other shape possessing sharp corners or apices as these could weaken the overall structure of the panel. Members of these shapes may however be used in some situations. It is also anticipated that the first member may take on a foil shape, being substantially oval in cross-section but having flattened sidewalls or having a pair of opposed arcuate sidewalls which meet each other. It is further preferred that the outer surface of the first members be substantially smooth to make it difficult to grasp or gain purchase thereupon without a gripping tool of appropriate kind.

The material used for construction of the each of the members may preferably be a light but strong metal such as aluminium or plastic. This will suitably provide the panel with the strength required to be used in security situations but remain light and slimmer in appearance than heavier or denser materials.

At least a portion of the first members may be hollow or tubular. Typically, the members will be entirely hollow, but it is envisaged that partially hollow, partially solid first members may be used. Suitably, at least one end portion of the first members may be hollow or tubular and preferably both end portions will be. The first members will also preferably be dimensionally stable or rigid enough to withstand deformation unless a substantial force is applied thereto.

The portion of the first members which is received in the lateral openings in the second member may be but are not essentially simply a part of the first member. For example, the portions to be received may be of the same or different shape and/or size to the first member itself. The first member may be provided with portions which are smaller in dimension at either end for example, and the smaller portions may be the engagement portions to be forces into the lateral openings in the second member. This may allow the main or central portion of each first member to abut or even overlap each other and still allow for the lateral openings in the second members to be spaced apart.

The shape of the network of members may be of any shape required by a consumer. Such shapes may be rectangular in appearance, but it may also be diamond shaped (or angled to the horizontal), or rounded in appearance. The shape of the panel and the network may also be abstract or freeform.

The arrangement of the network itself may preferably be an orderly array of members with the intersection of each first member with a second member providing a fixture point where the locking member attaches the first member to the second member. The fixture points may suitably be arranged in any two or three-dimensional pattern. Such pattern may be regular or abstract.

By varying structural dimensions and relationships in the assembly of the panel network, the relative area of any openings between the first members may be varied. The spacing of the members in the present invention may preferably be such that the openings are large enough to allow an unobstructed view or passage of air but small enough to provide security when necessary.

The openings in the panel may suitably be of any shape also, and will preferably be related to the array of the network.

The size of the panel may be varied to suit the application to which the panel is to be put. For example, when used as a screen panel in a fence, the panel will preferably be between 0.9 and 3 meters in height and 0.5 to 3 meters in width. More than one panel may be used to form a fence. When used in other situations, the panel will be suitably sized in order to achieve its purpose.

Each first member may preferably be round, rectangular or substantially oval in cross-sectional shape. It may also preferably have a cross-sectional shape having two substantially linear, parallel sidewalls and two arcuate end walls or foil-shaped. Each first member may have at least one sidewall.

Each first member may preferably be extruded. The extrusion may be of any length required. It is anticipated that U-shaped first members could be used to form a loop-top panel.

Each first member may have any dimensions, but preferably may be between approximately 1 cm and 10 cm in width, and any length.

Each first member preferably may be tubular in construction. The tubular construction will preferably provide strength and rigidity to the panel but not add excessive weight to the construction. However, a solid construction may preferably be used in specific situations. The or each first member may also have a planar configuration.

Planar first members are typically oriented with their longer dimension parallel to the second members but there may be occasions when the first members maybe angled relative to the second member. For example, an awning may be formed according to the present invention by using planar first members oriented substantially horizontally and downwardly angled with a pair or more of second members oriented substantially vertically. This configuration is more likely to be used with more planar first members. For example, a foil shaped first member will have a pair of surfaces which meet at side edges. According to the sloped configuration, the first members would be installed with the uppermost of the two side edges located behind the plane of the lower side edge and similarly for other shapes of first member.

There is at least one and suitably more than one second member disposed in the second direction. The plurality of first members will preferably take the form of paling or slat members disposed in one direction and the second members will suitably be disposed in a second direction to form a network. The first members and the at least one second member will typically be oriented approximately perpendicular to each other and the network will therefore preferably have a cross-like or screen-like appearance.

Depending upon the configuration of the panel and particularly upon the surrounding support structure, there may be a single second member provided or more typically, a pair of second members. Where a single second member is provided, the member will typically be located approximately centrally along the first members and normally the ends of the first members will be supported by a surrounding support structure. Alternatively, a single second member may be provided at an end of the first members to be used as a hand rail or similar.

Where a pair of second members is provided, each of the second members will normally be located at opposed ends of the first members. These second members will then typically be attached to a surrounding support structure which will effectively prevent removal of the second members from the ends of the first members. The second members may form part of a support frame and other members may be provided to form a closed frame which surrounds the first members. Brackets may be provided at the corners to attach the second members to the other portions of the frame.

The wall thickness of each second member will preferably be similar to the first members and be between approximately 0.5 mm and 10 mm. Thicker walls may be provided for members in larger panels, as those members will have to support a greater weight.

Each second member may preferably be substantially rectangular in cross-sectional shape, round, or substantially oval in cross-sectional shape. It may also preferably have a cross-sectional shape having two substantially linear, parallel sidewalls and two arcuate end walls or foil-shaped. Each second member may have at least one sidewall.

Each second member may preferably be extruded. The extrusion may be of any length required.

Each second member may have any suitable dimensions, but preferably may be between approximately 1 cm and 10 cm in a first direction, 1 mm to 10 cm in a second direction and of any suitable length.

Each second member may be solid, but preferably will be tubular in construction, with the longitudinal opening within the hollow interior. The tubular construction will preferably provide strength and rigidity to the panel but not add excessive weight to the construction. Solid construction may preferably be used in specific situations.

Each second member also has at a plurality of lateral openings disposed into or through it to receive the first members. These lateral openings may be passages and are suitably spaced along each second member.

The lateral openings may be provided with a longer dimension parallel to the longitudinal direction of the second member. However, the longer dimension may be angled with respect to the longitudinal direction of the second member, typically downwardly and outwardly oriented, and this configuration will have particular application to awnings, privacy screens and the like.

The wall thickness of each second member will preferably be similar and be between approximately 0.5 mm and 10 mm. Thicker walls may be provided for members in larger panels, as those members will have to support a greater weight. Typically, there will be an opening in one sidewall of the second member but not in the opposed sidewall of the second member so that an end portion of the first member may be received in the second member.

Each second member is preferably disposed substantially perpendicular to the first members to form a two-dimensional panel.

The second member also includes at least one locking member provided adjacent each lateral opening to abut a first member forced into the lateral opening, to lock the first member relative to the second member. Where a single locking arm is provided, the locking arm may be positioned to pinch the first member between the locking arm member and either the periphery of the lateral opening or a sidewall of the second member or other opposing assembly. Normally, a pair of opposed locking means will be provided, one on each side of each lateral opening.

The locking members will preferably each be an elongate arm member extending from a sidewall of the second member. Normally the arms will be located on the inside of the hollow second member. The arm members are normally oriented such that at least a portion of the arm extends from the sidewall in which the lateral openings are formed, with a free end. The arm members preferably extend over the length of the second member. For example, there will likely be a pair of locking members for each second member.

At least a portion of the arm member preferably extends to abut the first member at an acute angle. According to a particularly preferred embodiment, the arm members have a first portion and a second portion which are angled relative to one another and which form a corner along the length of the arm member. The corner is preferably the part of the arm member which abuts the first member and due to its shape, will likely have better locking characteristics than another part of the arm member. The first portion of the arm member is typically longer than the second portion. The first portion is also typically angled inwardly toward the lateral opening with the second portion angle away, with at least a portion of the arm member extending into the (plane of the) opening such that when a first member is forced into the lateral opening, the arm member must be deformed to allow the first member to pass.

It is particularly preferred that the spacing between the at least one locking member and the periphery of the opening or between the two locking members is narrower than the dimension of the first member which the locking member engages.

The arm member will normally be dimensionally stable and will be strong and rigid to resist deformation as the first member is inserted. Preferably, a significant force will be required to deform the arm members and as such, once inserted, the end of the first member will be tightly held by the locking arm members. The arm members will typically apply a significant compression force or “locking tension” on the first member inserted into the lateral opening.

A further anti-rattle means may be provided in the form of a spacing member adapted to be received about the first member and inside the periphery of the lateral opening in the second member. These anti-rattle means may particularly be used with metal first and second members and will typically be manufactured of plastic.

As may be appreciated, the invention is described herein with particular reference to a screen panel. It is to be appreciated that the invention may apply equally to an awning, balustrade or a roof structure as well. Other applications may become evident upon further explanation of the invention.

### BRIEF DESCRIPTION OF THE DRAWINGS

Various embodiments of the invention will be described with reference to the following drawings, in which:

FIG. 1 is an exploded perspective view of a panel according to an embodiment of the present invention configured as an awning.

FIG. 2 is an exploded perspective view of a panel according to an embodiment of the present invention with surround frame.

FIG. 3 is an exploded perspective view of a panel according to an embodiment of the present invention.

FIG. 4 is an exploded perspective view of a panel according to an embodiment of the present invention configured as an awning with a closed surround frame.

FIG. 5 is an exploded perspective view of a panel according to an embodiment of the present invention configured as a railing or balustrade.

FIGS. 6 to 12 are cross-sectional views of preferred cross-sectional shapes of first member.

FIGS. 13 to 20 are cross-sectional views of preferred cross-sectional shapes of second members with the location of the locking members and first members indicated thereon.

FIGS. 21 to 31 are cross-sectional views of preferred cross-sectional shapes of second members.

FIG. 32 is a perspective view of a balustrade panel according to a preferred embodiment of the present invention.

FIG. 33 is an exploded perspective view of a panel according to a preferred embodiment of the invention.

FIG. 34 is a partially exploded perspective view of a privacy screen panel according to a preferred embodiment of the invention.

FIG. 35 is an exploded perspective view of a panel with spacer blocks according to a preferred embodiment of the invention.

FIG. 36 is an exploded perspective view of a panel according to a preferred embodiment of the invention.

FIG. 37 is an exploded perspective view of a panel according to a preferred embodiment of the invention.

FIG. 38 is an exploded perspective view of a panel according to a preferred embodiment of the invention.

FIG. 39 is an exploded perspective view of a panel according to a preferred embodiment of the invention.

FIG. 40 is exceptional interview of a panel according to a further preferred embodiment of the invention.

### DETAILED DESCRIPTION OF THE PREFERRED EMBODIMENT

According to a preferred embodiment, a panel is provided.

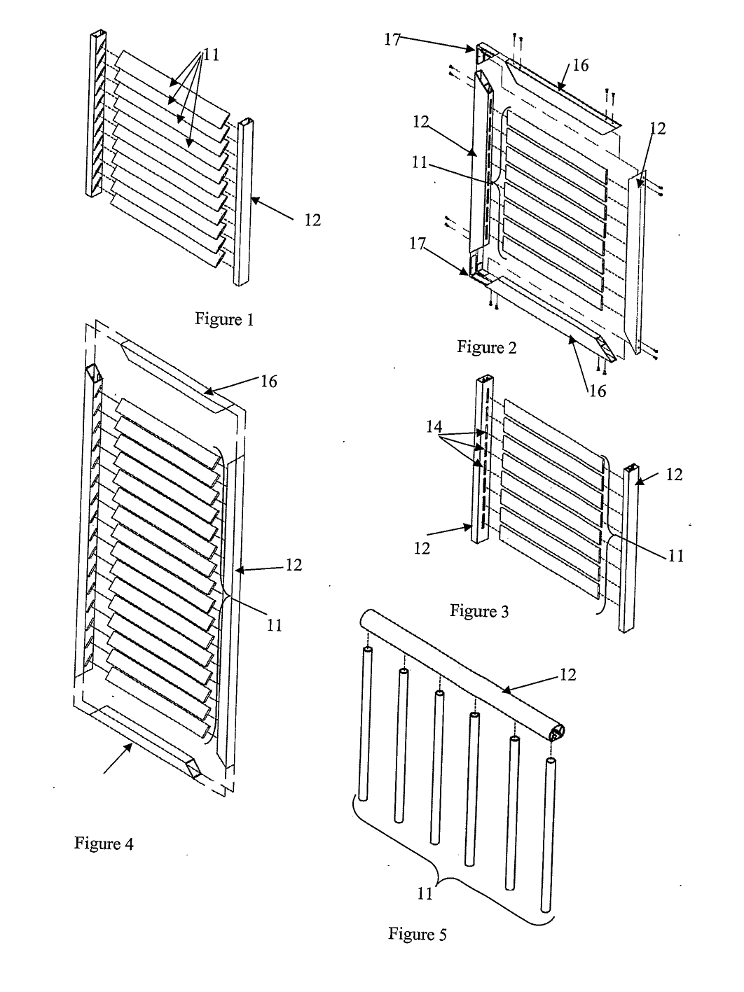

As illustrated in FIGS. 1 to 5 in particular, the panel 10 includes a plurality of first members 11 disposed in a first direction, and at least one second member 12 disposed in a second direction. The general configuration of members is illustrated in FIGS. 1 to 5 and although the first members 11 illustrated are oriented horizontally and the second members 12 vertically, it is of course anticipated that the members may be oriented in directions different to these.

The at least one second member 12 of the illustrated embodiments are hollow with a longitudinal opening 13 extending through the second member 12, a plurality of lateral openings 14 intersecting the longitudinal opening 13 to receive a portion of respective first members 11, and at least one locking member 15 provided adjacent each lateral opening 14 to abut a first member 11 forced into the lateral opening 14, to lock the first member 11 relative to the second member 12.

The locking members 15 of the illustrated embodiment are located inside the hollow interior of the second member 12 and therefore, are hidden from sight. Panels may be formed in this manner without rivets or other fasteners. The panel is also less likely to sag under its own weight. The removal of the overlapping slats and other fixing members or assemblies results in a slimmer panel which may be used in security situations as doors or window panels or in a larger form as a screen or wall panel. Depending upon the shape of the first 11 and second 12 members, the panel can also be used a roof (with un-spaced first members, balustrade such as that illustrated in FIG. 5 or awning such as that illustrated in FIG. 1 or 4. The panel may also be easily assembled by unskilled workers without the use of any specialized or heavy equipment. Due to the construction, the panel does not allow the first members to move relative to the second members and is thus an anti-rattle panel.

The plurality of first members 11 normally take the form of paling or slat members disposed in one direction and the second members 12 are normally disposed in a second direction to form a network. In the illustrated embodiments, the first members 11 and the second member(s) 12 are oriented perpendicularly to each other and the network has a screen-like, balustrade-like or awning-like appearance.

Depending upon the configuration of the panel 10 and particularly upon the surrounding support structure, there may be a single second member 12 provided or a pair of second members 12.

Where a single second member 12 is provided as in FIG. 5, the second member 12 can be provided at one end of the first members 11 to be used as a hand rail or similar. In this instance, the second member has a shape and configuration similar to that illustrated in FIG. 15 for example.

Where a pair of second members 12 is provided, each of the second members are normally be located at opposed ends of the first members 11. These second members 12 will then typically be attached to a surrounding support structure which will effectively prevent removal of the second members 12 from the ends of the first members 11. The second members 12 may form part of a support frame, such as that illustrated in FIGS. 2 and 4 for example, and other members 16 can be provided to form a closed frame which surrounds the first members 11. Brackets 17 will usually be provided at the corners to attach the second members 12 to the other members 16 of the surround frame.

According to the illustrated embodiment, the first members 11 are hollow or tubular with a longitudinal opening through the member 11. The first members 11 or the portion to be received in the lateral openings 14 in the second members 12 are also dimensionally stable or rigid enough to withstand deformation unless a substantial force is applied thereto.

Each first member 11 will typically be extruded and the extrusion may be of any length required.

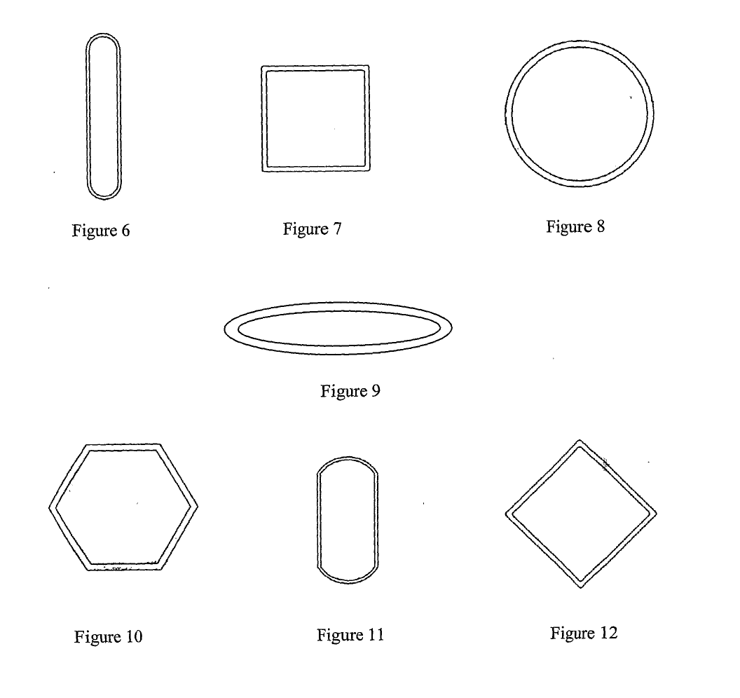

Planar first members such as those illustrated in FIGS. 6, 9 and 11 have a first dimension which is greater than a second dimension and are typically oriented with their longer dimension parallel to the second members 12 but there may be occasions when planar first members 11 may be angled relative to the second member 12. For example, an awning may be formed by using planar first members 11 oriented substantially horizontally and downwardly angled with a pair of second members 12 oriented substantially vertically. For example, a foil shaped first member such as that illustrated in FIG. 9 has a pair of surfaces which meet at side edges. According to the sloped configuration, the first members 11 are installed with the uppermost of the two side edges located behind the plane of the lower side edge such as that illustrated in FIG. 1.

Each second member 12 is also typically extruded and the extrusion may be of any length required. Each second member 12 is tubular in construction, with the longitudinal opening 13 within the hollow interior. The tubular construction provides strength and rigidity to the panel but does not add excessive weight to the construction.

Each second member 12 has a plurality of lateral openings 14 disposed into or through it to receive the first members 11. These lateral openings 14 are suitably spaced along each second member 12.

The lateral openings 14 for planar first members 11 are provided with a longer dimension parallel to the longitudinal direction of the second member 12. However, the longer dimension may be angled with respect to the longitudinal direction of the second member, typically downwardly and outwardly oriented, and this configuration will have particular application to awnings, privacy screens and the like.

Each second member 12 is preferably disposed substantially perpendicularly to the first members 11 to form a two-dimensional panel.

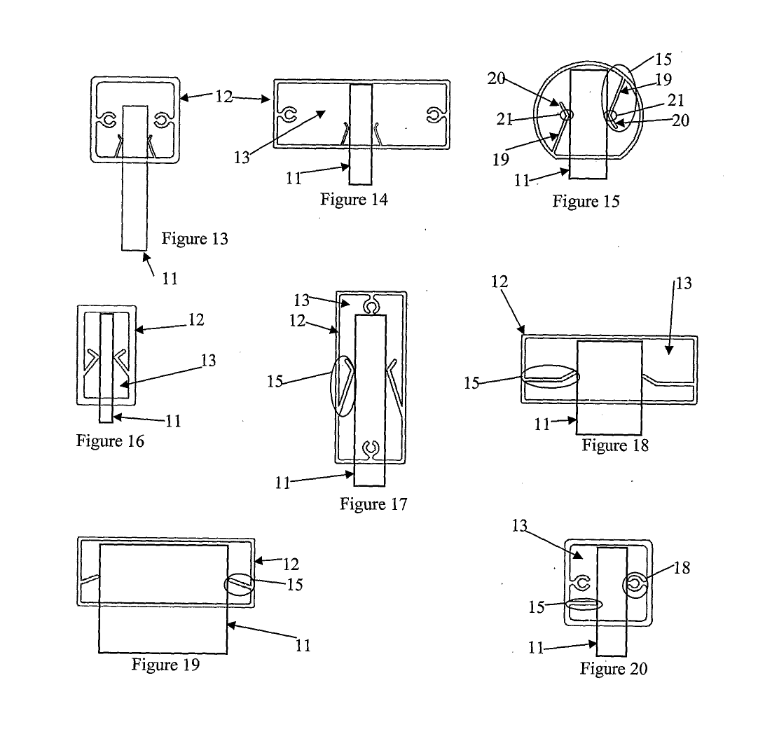

As illustrated in FIGS. 13 to 20, the second member 12 also includes at least one locking member 15 provided adjacent each lateral opening 14 to abut a first member 11 forced into the lateral opening 14, to lock the first member 11 relative to the second member 12. Where a single locking member or arm 15 is provided such as illustrated in FIG. 20, the locking arm 15 may be positioned to pinch the first member between the locking arm member and either the periphery of the lateral opening or a sidewall of the second member or other opposing assembly, such as a fastener guide 18. Normally, a pair of opposed locking arms 15 are provided, one on each side of each lateral opening 14.

The locking members 15 of the illustrated embodiment are an elongate arm member extending from a sidewall of the second member 12. The arm members 15 are normally oriented such that at least a portion of the arm 15 extends from the sidewall in which the lateral openings 14 are formed, with a free end such as those illustrated in FIGS. 13 and 14. The arm members extend over the length of the second member 12. The arm members may alternatively extend from other sidewalls of the second member such as those illustrated in FIGS. 15, 16, 17, 18 and 19.

At least a portion of the arm member normally extends to abut the first member 11 at an acute angle such as in FIGS. 13 to 17, but other configurations may be used such as those in FIGS. 18 to 20. According to a particularly preferred embodiment, the arm members 15 have a first portion 19 and a second portion 20 which are angled relative to one another and which form a corner 21 along the length of the arm member 15. The corner 21 is normally the part of the arm member 14 which abuts the first member 11 and due to its shape, will likely have better locking characteristics than another part of the arm member 11. The first portion 19 of the arm member 15 is typically longer than the second portion 20. The first portion 19 is also typically angled inwardly toward the lateral opening 14 with the second portion 20 angled away, with at least a portion of the arm member 15 extending into the (plane of the) opening such that when a first member 11 is forced into the lateral opening 14, the arm member 15 must be deformed to allow the first member 11 to pass.

It is particularly preferred that the spacing between the at least one locking member 15 and the periphery of the lateral opening 14 or between the two locking members 15 is narrower than the dimension of the first member 11 which the locking member(s) 15 engages.

The locking arm member 15 is dimensionally stable and will be strong and rigid to resist deformation as the first member 11 is inserted. Preferably, a significant force is required to deform the arm members 15 and as such, once inserted, the end of the first member 11 is tightly held by the locking arm members 15. The arm members 15 typically apply a significant compression force or “locking tension” on the first member 11 inserted into the lateral opening.

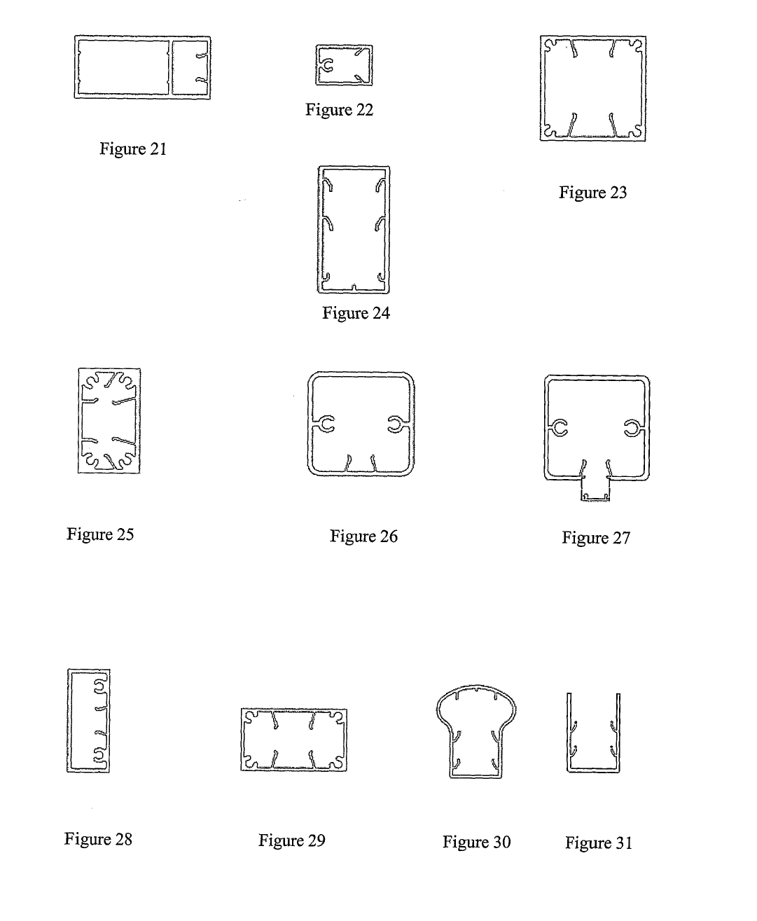

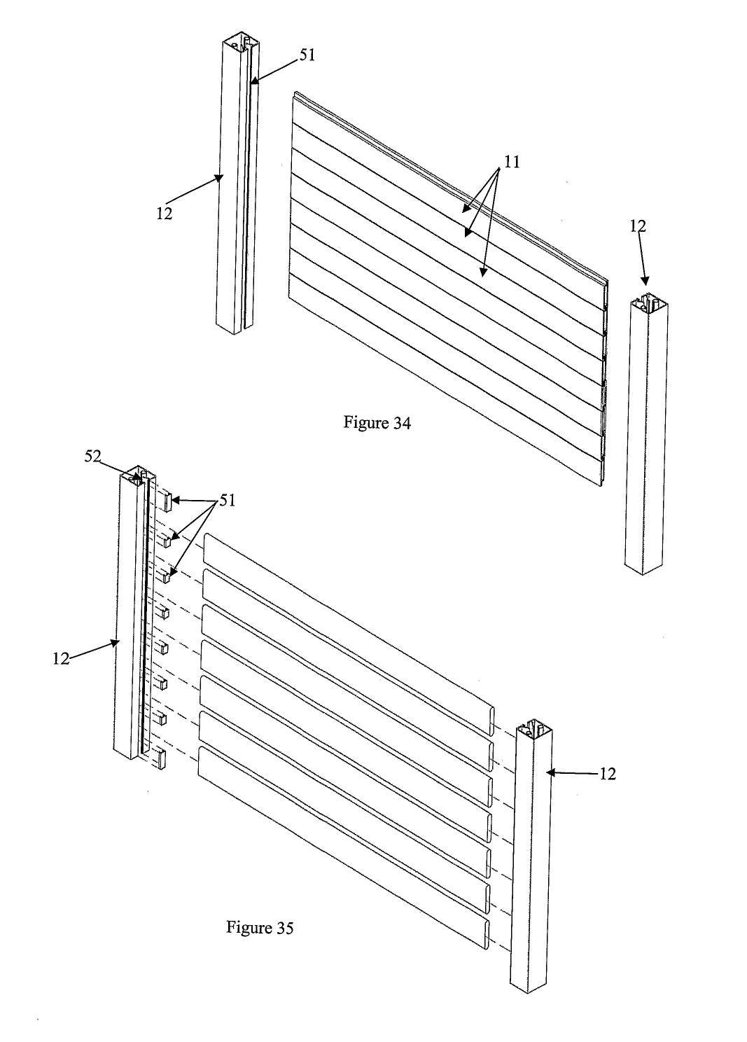

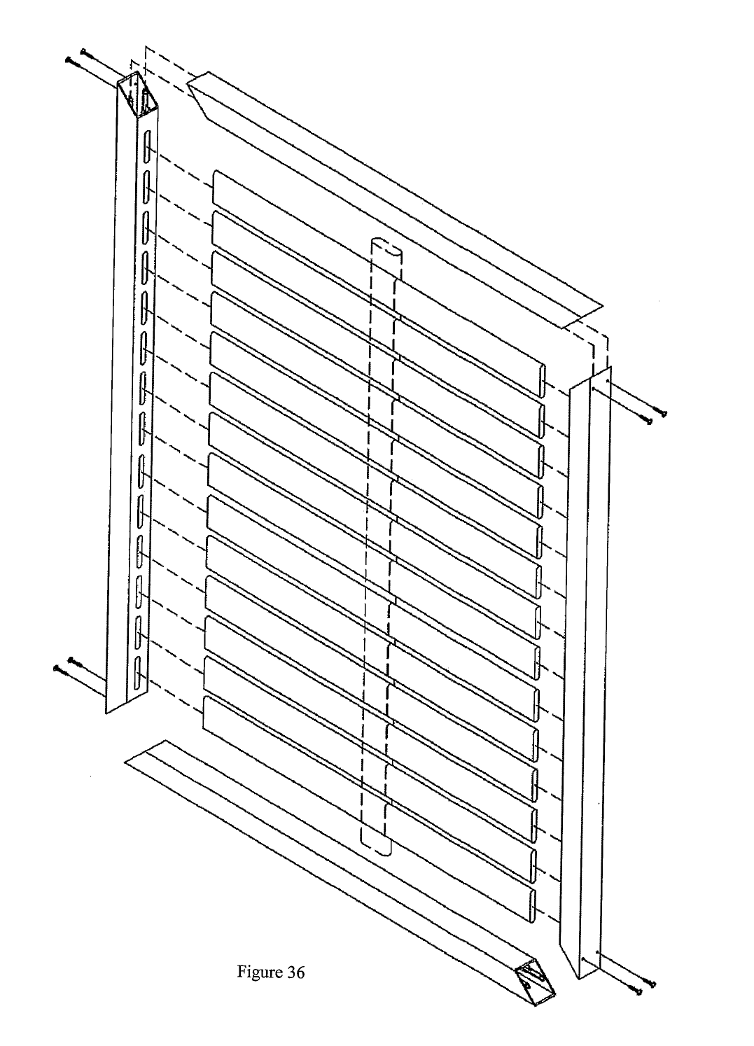

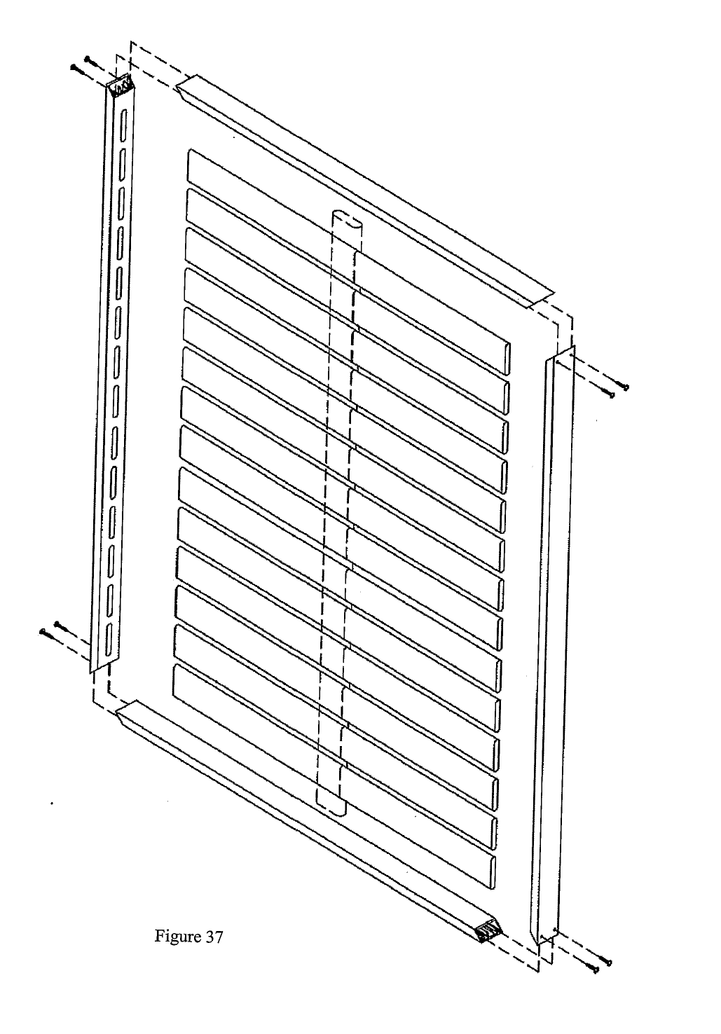

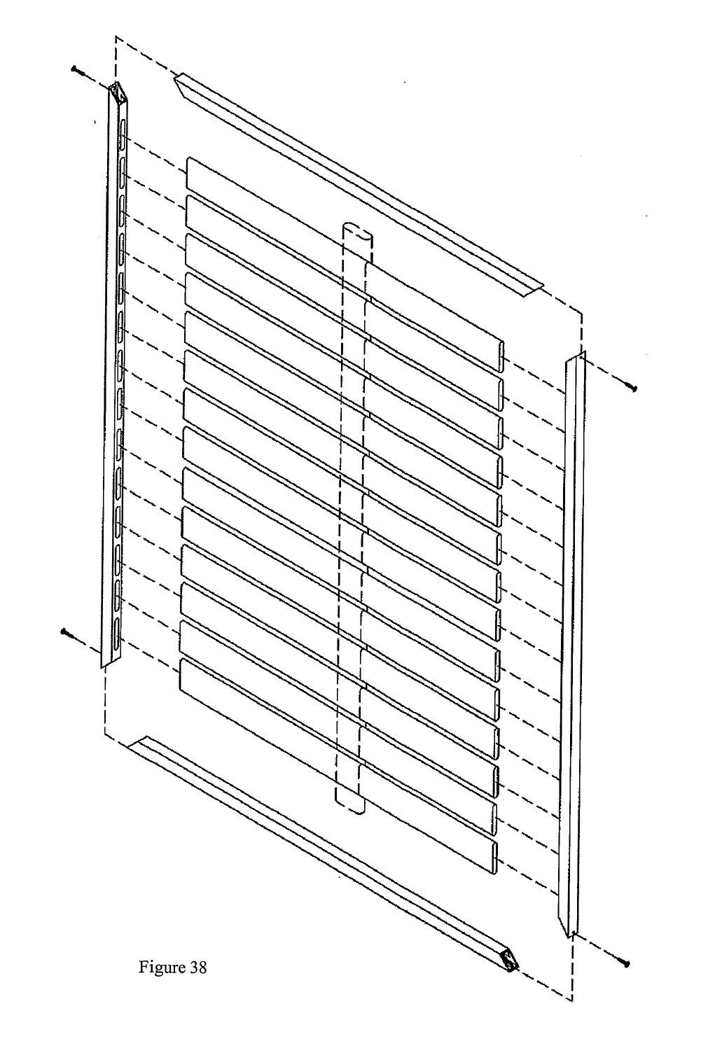

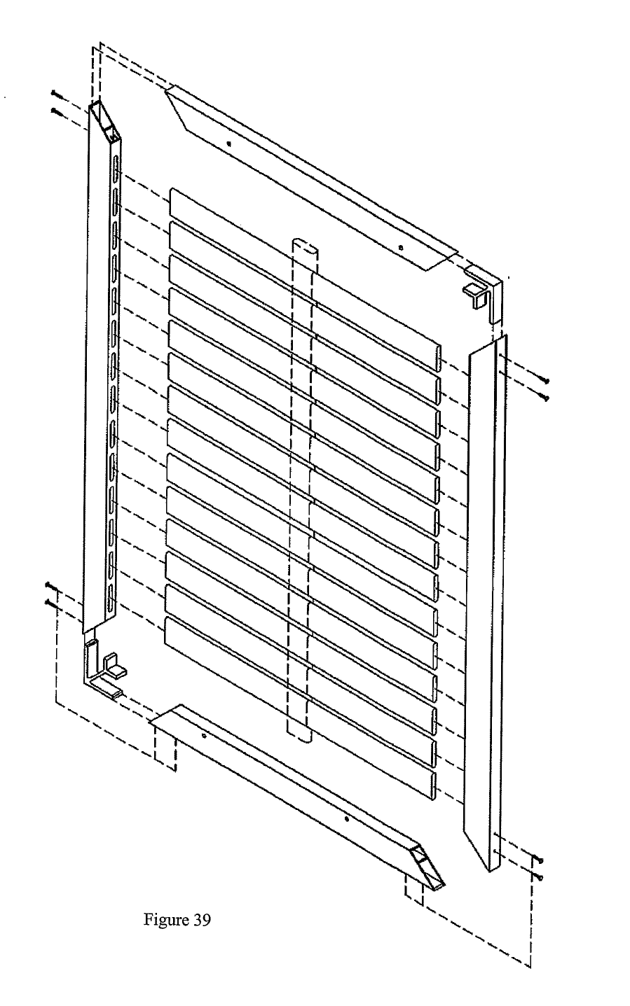

FIGS. 21 to 31 show various cross-sectional shapes of second members, some of which are shown in FIGS. 13 to 20, but without the first members. FIG. 26 is particularly highlighted as being an open channel member and a spacer block 50 is illustrated. Second members configured similarly to illustrated in FIG. 26 are used to manufacture panels, a form of which is illustrated in FIG. 35. In particular, the second member illustrated in FIG. 26 has an opening extending substantially over the height of the member. Once the second members are in location, alternating spacer blocks 50 and first members 11 are placed into the opening 51 with the spacer blocks 50 separating the first members 11 in a configuration differently to the discrete openings used in other embodiments.

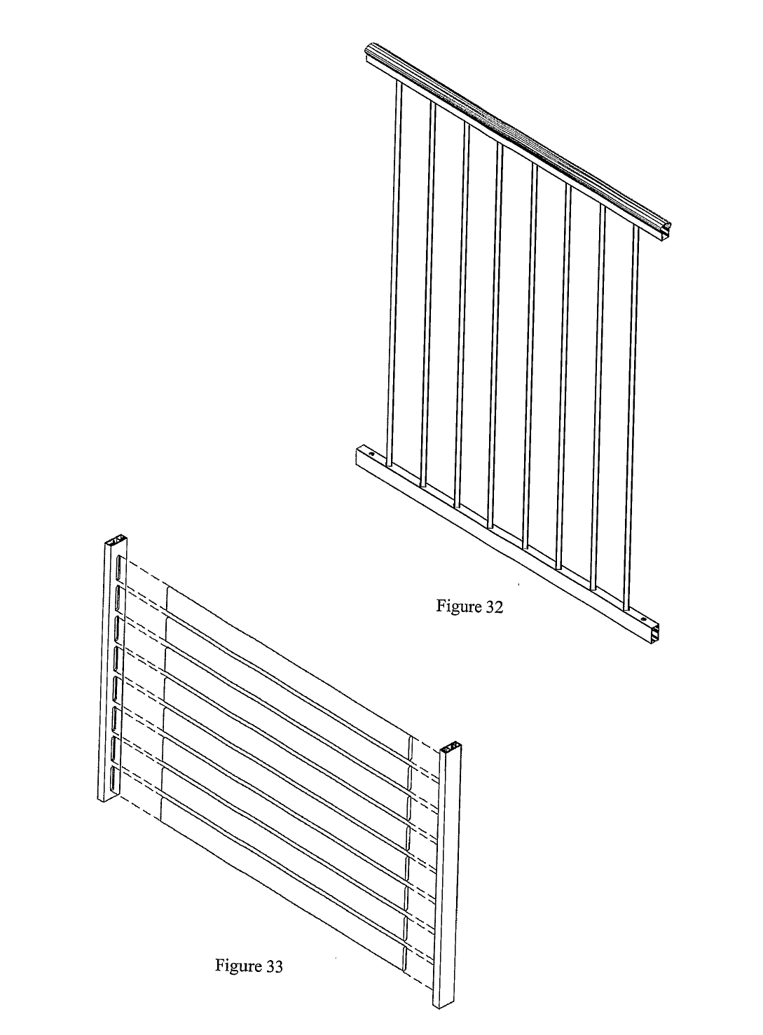

The cross-sectional shape illustrated in FIG. 31 is also specifically highlighted as this cross-sectional shape also has a substantially open channel formed by the removal, or absence of a side wall of the second member.

It is also to be noted that some of the cross-sectional shapes of second member illustrated have at least two pairs of locking arms, for example the embodiments illustrated in FIGS. 23 to 25 and FIGS. 29 to 31. The provision of more than one pair of locking arms provides the ability to form panels with superior security of attachment of the first members to the second members, even compared to second members having a single pair of locking arms.

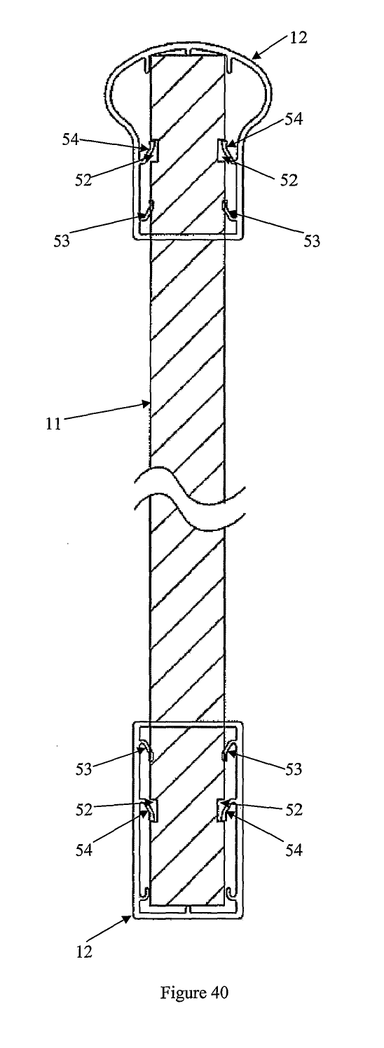

A panel of this form is illustrated in FIG. 40. As can be seen from FIG. 40, each first member 11 is provided with a laterally extending slot opening 52 spaced from the terminus of each end and on opposed sides of the first member 11. As the first member 11 is forced into the second members 12, the first pair of locking arms 53 adjacent the insertion opening are slightly deformed by the terminus and as the first member 11 is forced further into the second member 12, the adjacent pair of locking arms 54 are also deformed. Continued insertion of the first member 11 into the second member 12 forces the slot openings 52 past the first pair of locking arms 53 adjacent to the insertion opening and these locking arms 53 continue to apply tension to the full thickness portion of the first member 11. The second pair of locking arms 54 are received at least partially in the laterally extending slot openings 52 and abut the edge of the slot opening 52, further increasing security and making removal of the first member 11 from the second member 12 far more difficult.

Also to be highlighted in the Figures is the panel illustrated in FIG. 34. This panel also utilises the second member 12 having a configuration of FIG. 26 with an opening 51 extending substantially over the height of the second member 12. In contrast to the embodiment illustrated in FIG. 35, the panel of FIG. 34 is a privacy screen in which the first members 11 are not spaced apart, but abut each other. Any type of abutment is possible, however the embodiment illustrated in FIG. 34 includes a rebate or tongue formed on one edge of each first member with a corresponding rebate or opening form on the opposite page of each first member, the rebates or tongue and opening adapted to provide engagement between the first members when they abut to strengthen the panel.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. (canceled)

2. A panel including
a. a plurality of first members disposed in a first direction,
b. at least one second member disposed in a second direction provided with
i. a longitudinal opening extending at least partially through the at least one second member;
ii. a lateral opening intersecting the longitudinal opening to receive at least a portion of respective first members, and
iii. at least one locking member provided adjacent each lateral opening to abut a first member forced into the lateral opening, to lock the first member relative to the second member through application of compressive force to the first member.

3. A panel according to claim 2 wherein, the second member is at least partially hollow and the at least one locking member is located inside the second member hidden from sight.

4. A panel according to claim 2 wherein each first member is an elongate member.

5. A panel according to claim 2 wherein at least a portion of the first members is hollow or tubular.

6. A panel according to claim 2 wherein the first members are dimensionally stable or rigid enough to withstand deformation unless a substantial force is applied thereto.

7. A panel according to claim 2 wherein more than one second member is provided in the second direction.

8. A panel according to claim 7 wherein a pair of second members is provided, each of the second members located at opposed ends of the first members.

9. A panel according to claim 8 wherein the second members form part of a support frame and other members are provided to form a closed frame which surrounds the first members.

10. A panel according to claim 2 wherein the lateral opening comprises a plurality of lateral openings spaced along each second member.

11. A panel according to claim 2 wherein the lateral opening comprises a plurality of lateral openings have a longer dimension parallel to the longitudinal direction of the at least one second member.

12. A panel according to claim 10 wherein the lateral opening comprises a plurality of lateral openings having a longer dimension, the longer dimension angled with respect to the longitudinal direction of the second member.

13. A panel according to claim 2 wherein the lateral opening comprises a plurality of lateral openings including an opening in a first sidewall of the second member but not in an opposed sidewall of the second member.

14. A panel according to claim 2 wherein a single locking member is provided, the locking member positioned to pinch the first member between the locking member and another opposing assembly in the second member.

15. A panel according to claim 1 wherein a pair of opposed locking members are provided, one on each side of each lateral opening.

16. A panel according to claim 2 wherein each locking member is an elongate arm member extending from a sidewall of the second member.

17. A panel according to claim 2 wherein at least a portion of each locking member extends to abut the first member at an acute angle.

18. A panel according to claim 2 wherein each locking member has a first portion and a second portion which are angled relative to one another and which forms a corner along the length of the arm member to abut the first member.

19. A panel according to claim 18 wherein the first portion is angled inwardly toward the lateral opening relative to which it is located with the second portion angled away, with at least a portion of the arm member extending into the plane of the lateral opening such that when a first member is forced into the lateral opening, the arm member must be deformed to allow the first member to pass.

20. A panel according to claim 2 wherein the at least one locking member and the periphery of each at least one lateral opening are separated by a distance narrower than the dimension of the first member which the locking member engages.

21. A panel according to claim 15 wherein or between the two locking members are separated by a distance narrower than the dimension of the first member which the locking members engage.

22. A panel according to claim 2 wherein the at least one locking member is dimensionally stable, and rigid to resist deformation as the first member is inserted.

23. A panel according to claim 2 further including anti-rattle spacing member adapted to be received about the first member and inside the periphery of the lateral opening in the second member.

24. A panel according to claim 2 wherein a single second member is provided, and is located approximately centrally along the first members, the ends of the first members supported by a surrounding support structure.

25. A panel according to claim 2 wherein a single second member is provided at an end of the first members to be used as a hand rail or similar.

26. A panel according to claim 2 wherein a second member is a member having an opening extending substantially over the length of the member.

27. A panel according to claim 26 wherein the first members are inserted into the opening and spaced over the length of the second member by spacer members inserted into the opening between the first members.

28. A panel according to claim 26 wherein the first members are inserted into the opening and abut each other.

29. A panel according to claim 28 wherein the first members are provided with shaped portions to engage each other.

30. A panel according to claim 2 wherein the first members are oriented at an angle other than perpendicular to the second members.

31. A panel according to claim 2 wherein more than one pair of opposed locking members are provided on a second member, each pair having one locking member on each side of each lateral opening and at least some first members have at least one slot opening extending substantially in the direction of the second member, with at least one of the locking members adapted to being received at least partially in a slot opening when the first member is attached to the second member.
